(19) United States
(12) Patent Application Publication
(10) Pub. No.: US 2016/0309230 A1
(43) Pub. Date: Oct. 20, 2016

(54) METHOD AND SYSTEM FOR SIMULTANEOUS PLAYBACK OF DESKTOP BACKGROUND AND LIVE BROADCAST INTERFACE

(71) Applicants: LE SHI INTERNET INFORMATION TECHNOLOGY CORP. BEI JING, Beijing (CN); LE HOLDINGS (BEIJING) CO., LTD., Beijing (CN)

(72) Inventor: Yang LI, Beijing (CN)

(73) Assignees: LE HOLDINGS (BEIJING) CO., LTD., Beijing (CN); LE SHI INTERNET INFORMATION TECHNOLOGY CORP. BEIJING, Beijing (CN)

(21) Appl. No.: 15/101,906

(22) PCT Filed: Nov. 25, 2014
(86) PCT No.: PCT/CN2014/092210

§ 371 Date: Jun. 4, 2016

(30) Foreign Application Priority Data
Dec. 6, 2013 (CN) 201310657091.1

(51) Int. Cl. H04N 21/472; H04N 21/43; H04N 21/643; H04N 21/433; H04N 21/262; H04N 21/61

(52) U.S. Cl. CPC H04N 21/472; H04N 21/26283; H04N 21/262; H04N 21/6125; H04N 21/64322; H04N 21/47217; H04N 21/4331; H04N 21/43

(57) ABSTRACT

Disclosed are a method and system for simultaneous playback of a desktop background and a live broadcast interface. The method comprises: by scheduling a live broadcast port of a desktop background, acquiring a live broadcast station name corresponding to a program being played back in the desktop background; from live broadcast station information acquired on the basis of the live broadcast station name, extracting a program list address and a live broadcast station broadcast address; when entering the live broadcast interface, time-comparing a queried live broadcast station current time with program list information acquired on the basis of the program list address to look up a program that is being played back at the current time, looking up the program via the live broadcast station address and simultaneously playing back in the live broadcast interface.

The preset application claims the priority benefit of Chinese Patent Application No. 2013106570911, submitted to the Patent Office of the People's Republic of China, entitled “Method and System for Simultaneously Broadcasting Desktop Background and Live Broadcast Interface”, and filed on Dec. 6, 2013, the entire contents of which are incorporated herein by reference.

### TECHNICAL FIELD

The present disclosure relates to the field of Internet TV broadcasting interface, and more particularly to a method, a system and an apparatus for simultaneously broadcasting a desktop background and a live broadcast interface.

### BACKGROUND

In the prior art, the Internet TV, as a brand-new technology that is integrated with Internet, multi-media, communication and various technologies as a whole and provides multiple interactive type services including the digital TV for domestic TV users, combines the strong network function with the TV client, so that people cannot only watch programs of the TV station, but also can find various programs intended to be watched in the abundant network resources through the Internet function.

The Internet TV provides all-directional media services for all broadband terminal users by taking the broadband network as a carrier and the interactive individuation as a character in the form of video-audio multimedia. The Internet TV launched under the background of digitization and networking is a product that combines the Internet technology with the TV technology. During the course of integrating two communication media of the TV and the network, the Internet TV not only retains the intuitive, vivid and agile performance characteristics of the TV image, but also has the interactive feature acquired by the Internet according to the requirements. The Internet TV is a new communication mode that is produced by synthesizing the advantages of two communication media.

Currently, the main menu interface of the Internet TV is accessed after starting the Internet TV by the user. Different content options are set on the main menu interface, which provides various types of abundant media service options for the user. The desktop background of the main menu interface will broadcast the live broadcast program in multiple different live broadcast stations of the service end of the Internet TV, so that the user may not only select the different content options in the main menu interface, but also watch the program being broadcasted in the desktop background of the main menu interface.

Particularly, the user can watch the program broadcasted in the desktop background of the main menu interface if accessing the corresponding live broadcast interface through the selection operation. However, the program broadcasted in the live broadcast interface is broadcasted by randomly selecting the multiple different live broadcast stations of the service end of the Internet TV, and the program watched by the user after accessing the live broadcast interface is not the same as the program broadcasted in the desktop background of the main menu interface.

### SUMMARY

In view of this, the technical problem to be solved in the present disclosure is to provide a method, a system and an apparatus for simultaneously broadcasting a desktop background and a live broadcast interface, to solve a simultaneously broadcasting problem between the desktop background and the live broadcast interface.

In order to solve the above technical problem, the present disclosure discloses a method for simultaneously broadcasting a desktop background and a live broadcast interface, including:

acquiring a live broadcast station name corresponding to a program being broadcasted in the desktop background by calling a live broadcast interface of the desktop background;

extracting a program list address and a live broadcast station broadcast address from live broadcast station information acquired according to the live broadcast station name; and

when accessing the live broadcast interface, time-comparing a queried live broadcast station current time with program list information acquired through the program list address to look up a program that is broadcasted at the current time, looking up the program through the live broadcast station broadcast address and simultaneously broadcasting in the live broadcast interface.

Preferably, acquiring the live broadcast station name corresponding to the program being broadcasted in the desktop background by calling the live broadcast interface of the desktop background further includes:

when broadcasting the program in the desktop background, detecting the live broadcast interface of a broadcast thread corresponding to the desktop background, and extracting the live broadcast station name corresponding to the program from the live broadcast interface of the broadcast thread.

Preferably, before extracting the program list address and the live broadcast station broadcast address from live broadcast station information acquired according to the live broadcast station name, the method further includes:

querying the corresponding live broadcast station according to the live broadcast station name, and acquiring the corresponding live broadcast station information through a query interface of the live broadcast station.

Preferably, time-comparing the queried live broadcast station current time with program list information through the program list address to look up the program that is broadcasted at the current time, looking up the program through the live broadcast station broadcast address and simultaneously broadcasting in the live broadcast interface further includes:

accessing the program list address of the live broadcast station to acquire the program list information, time-comparing with the live broadcast station current time queried by accessing, and looking up the program that is broadcasted at the current time in the program list represented by the program list information;

accessing the broadcast address of the live broadcast station to look up the program; and

simultaneously broadcasting the queried program in the live broadcast interface according to the broadcast time schedule of the program broadcasted in the desktop background.

Preferably, the method further includes:

querying the broadcast address of the live broadcast station; accessing the live broadcast station according to the queried broadcast address of the live broadcast station, and looking up the corresponding program content of the program that is broadcasted in the desktop background in the live broadcast station to perform the broadcast cache processing.

In order to solve the technical problems above, the present disclosure further discloses a system for simultaneously broadcasting a desktop background and a live broadcast interface, which is coupled with a live broadcast station. The system includes a detection unit, a query unit and a simultaneous broadcast unit, wherein:

the detection unit is configured to acquire the live broadcast station name corresponding to the program being broadcasted in the desktop background by calling the live broadcast interface of the desktop background and send to the query unit;

the query unit is configured to extract a program list address and a live broadcast station broadcast address from live broadcast station information acquired according to the live broadcast station name; and

the simultaneous broadcast unit is configured to time-compare a queried live broadcast station current time with program list information acquired through the program list address to look up a program that is broadcasted at the current time when accessing the live broadcast interface, look up the program through the live broadcast station broadcast address and simultaneously broadcast in the live broadcast interface.

Preferably, the detection unit is further configured to:

detect the live broadcast interface of a broadcast thread corresponding to the desktop background when broadcasting the program in the desktop background, and extract the live broadcast station name corresponding to the program from the live broadcast interface of the broadcast thread.

Preferably, the query unit is further configured to:

query the corresponding live broadcast station according to the live broadcast station name, and acquire the corresponding live broadcast station information through a query interface of the live broadcast station.

Preferably, the simultaneous broadcast unit is further configured to:

access the program list address of the live broadcast station to acquire the program list information, time-compare with the live broadcast station current time queried by accessing, look up the program that is broadcasted at the current time in the program list represented by the program list information, access the broadcast address of the live broadcast station to look up the program, and simultaneously broadcast the queried program in the live broadcast interface according to the broadcast time schedule of the program broadcasted in the desktop background.

Preferably, the system further includes:

a cache unit, configured to query the broadcast address of the live broadcast station; access the live broadcast station according to the queried broadcast address of the live broadcast station, and look up the corresponding program content of the program that is broadcasted in the desktop background in the live broadcast station to perform broadcast cache processing.

Compared with the prior art, the method and system for simultaneously broadcasting the desktop background and the live broadcast interface described in the present disclosure achieve the following effects:

1) After a user accesses the main menu interface of the Internet TV, the present disclosure may immediately acquire the live broadcast station information corresponding to the program broadcasted by the desktop background of the main menu interface, and query the corresponding live broadcast station according to the live broadcast station information, which effectively solves the simultaneous broadcast problem between the desktop background and the live broadcast interface.

2) The present disclosure may further query a uniform live broadcast station through the live broadcast station information, which ensures the program broadcasted by the desktop background of the main menu interface is consistent with the program broadcasted by the live broadcast interface, and effectively improves the watching experience of the user.

Of course, any one product for implementing the present disclosure does not have to achieve all technical effects described above at the same time.

### BRIEF DESCRIPTION OF THE DRAWINGS

The drawings described herein are used for providing further understanding on the present disclosure, and form a part of the present disclosure. The exemplary embodiments of the present disclosure and the description hereof are used for explaining the present disclosure, but not formed as an inappropriate limitation on the present disclosure. In the drawings:

FIG. 1 is a flow block diagram of a method for simultaneously broadcasting a desktop background and a live broadcast interface according to a first embodiment of the present disclosure;

FIG. 2 is a flow block diagram of a method for simultaneously broadcasting a desktop background and a live broadcast interface according to a second embodiment of the present disclosure;

FIG. 3 is a structure block diagram of a system for simultaneously broadcasting a desktop background and a live broadcast interface according to a fourth embodiment of the present disclosure; and

FIG. 4 is a structure block diagram of a system for simultaneously broadcasting a desktop background and a live broadcast interface according to a fifth embodiment of the present disclosure.

FIG. 5 is a structure block diagram of an apparatus for simultaneously broadcasting a desktop background and a live broadcast interface according to a sixth embodiment of the present disclosure.

### DETAILED DESCRIPTION

For instance, some vocabularies are used in the description and the claim to refer to designated components. Those skilled in the art should understand hardware manufacturers may employ different nouns to name the same component. According to the description and the claim, the difference in the name is not deemed as a way to distinguish the components, but the difference in the function is deemed as the norm to distinguish the components. For example, “include” as mentioned through the description and the claim is an open type term, so it should be explained as “include, but not limited to”. “Approximately” refers to that the technical problems may be solved by those skilled in the part within the certain error scope to basically achieve the technical effects within the receivable error scope. In addition, one term “coupling” includes any direct or indirect electrically coupling means herein. Therefore, if a first device being coupled to a second device is described herein, it represents that the first device may be directly electrically coupled to the second device, or indirectly electrically coupled to the second device through other devices or a coupling means. A preferred implementing manner of the present disclosure is described in the description hereinafter, but the description is to describe the general principle of the present disclosure, but not intended to limit the scope of the present disclosure. The protection scope of the present disclosure should be subjected to those defined by the claims.

### First Embodiment

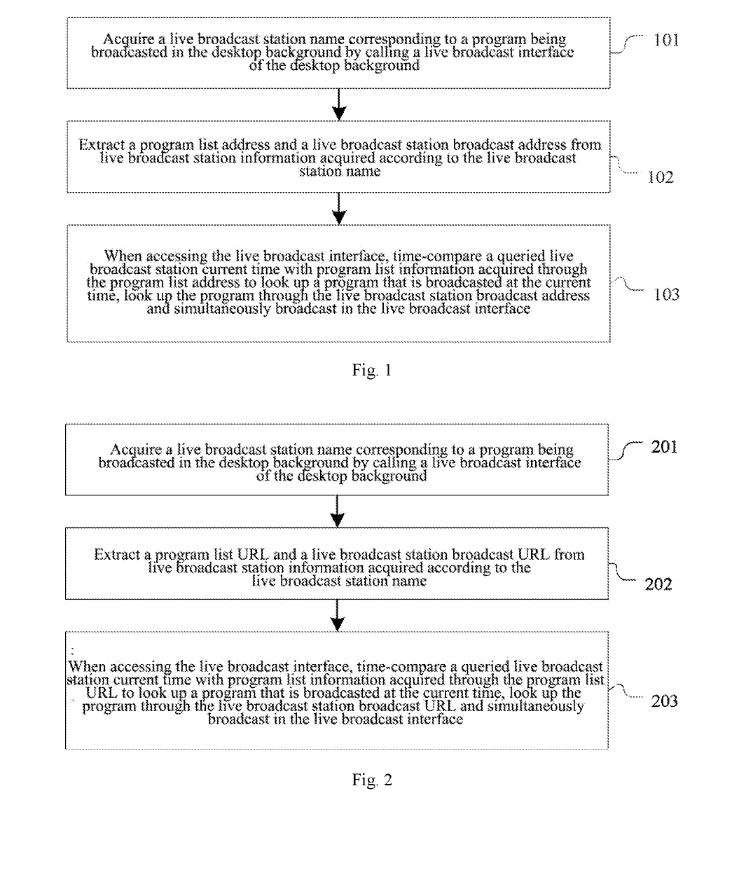

FIG. 1 shows a method for simultaneously broadcasting a desktop background and a live broadcast interface described by the first embodiment of the present disclosure. The method includes the following steps.

In step 101, a live broadcast station name corresponding to a program being broadcasted in the desktop background is acquired by calling a live broadcast interface of the desktop background.

For the Internet TV, multiple different live broadcast stations are provided at the service end to broadcast the video programs with abundant contents. The programs broadcasted in the desktop background of the main menu interface are selected to broadcast in the different live broadcast stations randomly. That is to say, when the user starts the Internet TV to access the main menu interface, the programs broadcasted in the desktop background may be movies and TV series, music, variety or news and other different videos. If the user can watch the programs in the current desktop background, the live broadcast interface of the desktop background needs to be acquired, the related information of the live broadcast station corresponding to the program is acquired, and the program information is further acquired by the related information of the live broadcast station.

In step 102, a program list address and a live broadcast station broadcast address are extracted from live broadcast station information acquired according to the live broadcast station name.

Different live broadcast stations may be set either in the same server or in different servers. If the user simultaneously broadcasts the corresponding video programs through the live broadcast interface, the corresponding live broadcast station needs to be queried in the domain name of the server or the name of the live broadcast station. Accordingly, for the step 102, the live broadcast name may be specifically the name of the live broadcast station or the server domain name address corresponding to the live broadcast station, and so on.

In step 103, when accessing the live broadcast interface, time-comparing is performed for a queried live broadcast station current time with program list information acquired through the program list address to look up a program that is broadcasted at the current time, the program is looked up through the live broadcast station broadcast address and simultaneously broadcasted in the live broadcast interface.

It should be noted that the service end (which is specifically as a server) corresponding to the program broadcasted in the desktop background is inconsistent with the server end corresponding to the program broadcasted in the live broadcast interface in the practical disclosure (however, the live broadcast station is the same). Therefore, in the present embodiment, after querying the corresponding live broadcast station through the program in the desktop background and then simultaneously broadcasting, a certain delay phenomenon may be happened (the solution on the delay phenomenon will be described in the embodiment hereinafter), but not affect the watching experience of the user.

### Second Embodiment

FIG. 2 shows a method for simultaneously broadcasting a desktop background and a live broadcast interface described by the second embodiment of the present disclosure. The method includes the following steps.

In step 201, a live broadcast station name corresponding to a program being broadcasted in the desktop background is acquired by calling a live broadcast interface of the desktop background.

In step 201, the live broadcast interface of a broadcast thread corresponding to the desktop background is detected when broadcasting the program in the desktop background, and the live broadcast station name corresponding to the program is extracted from the live broadcast interface of the broadcast thread.

In the embodiment, the broadcast thread may be a broadcast thread at the bottom layer of the Internet TV system. The data flow (transmission type of video formed during the course of transmission) transmitted from the service end is converted by the broadcast thread into a video program through the corresponding live broadcast interface to broadcast. The corresponding live broadcast station name is written by the live broadcast station of the service end in the data corresponding to the video program in a mode of information identifier according to setting. When the video program is transmitted, the information identifier may be extracted from the live broadcast interface of the broadcast thread, so as to further acquire the live broadcast station name.

In step 202, a program list address URL (Uniform Resource Locator) and a live broadcast station broadcast URL are extracted from the live broadcast station information acquired according to the live broadcast station name.

The step 202 is specifically as follows: the corresponding live broadcast station is queried according to the live broadcast station name, and the corresponding live broadcast station information is acquired through a query interface of the live broadcast station.

It should be noted that the schedule of the programs to be broadcasted in the live broadcast station is stored in the program list address (URL), and the programs are broadcasted by the live broadcast station in strict accordance with the program sequence and program time of the program list.

Different live broadcast stations may be set either in the same server or in different servers. If the user simultaneously broadcasts the corresponding video programs through the live broadcast interface, the corresponding live broadcast station needs to be queried in the domain name of the server or the name of the live broadcast station. Accordingly, for the step 202, the live broadcast name may be specifically the name of the live broadcast station or the server domain name address corresponding to the live broadcast station, and so on.

In step 202, the live broadcast station broadcast address and the program list address may be specifically URL. Each live broadcast station in the service end of the Internet TV is provided with a unique URL. The correct access broadcast may be performed after looking up the URL.

In step 203, when accessing the live broadcast interface, time-comparing is performed for a queried live broadcast station current time with program list information acquired through the program list URL to look up a program that is broadcasted at the current time, the program is looked up through the live broadcast station broadcast URL and simultaneously broadcasted in the live broadcast interface.

As the service end (a server to be specific) corresponding to the program broadcasted in the desktop background is inconsistent with the service end corresponding to the program broadcasted in the live broadcast interface, the broadcast address of the live broadcast station in the service end corresponding to the live broadcast interface will be accessed when recognizing that the user starts the operation of the live broadcast interface, which causes that the video program broadcasted has a certain delay phenomenon after querying the corresponding live broadcast station by the live broadcast station name corresponding to the program in the desktop background and simultaneously broadcasting.

In order to slow down the delay phenomenon during the course of simultaneously broadcasting, in the step 203 of the embodiment, the program list address of the live broadcast station is accessed to acquire the program list information when accessing the live broadcast interface, time-comparing is performed with the live broadcast station current time queried by accessing, the program that is broadcasted at the current time in the program list represented by the program list information is looked up, the broadcast address of the live broadcast station is accessed to look up the program, and the queried program is simultaneously broadcasted in the live broadcast interface according to the broadcast time schedule of the program broadcasted in the desktop background.

In the embodiment, the broadcast address of the live broadcast station is queried; the live broadcast station is accessed according to the queried broadcast address of the live broadcast station, and the corresponding program content of the program that is broadcasted in the desktop background in the live broadcast station is looked up to perform the broadcast cache processing. Accordingly, a certain duration of video program is broadcasted in the live broadcast station is cached locally. When accessing the live broadcast interface, the user may directly broadcast the data cached locally, which does not cause the delay of the simultaneously broadcasting. Of course, the cache processing mode and the caching data storage position may employ the other modes, but not limited to the present disclosure.

It should be noted that the video program broadcasted is cached according to the preset duration when caching, for instance: the caching duration is set as 5 s, that is, the Internet TV pre-caches and downloads the video program of the corresponding live broadcast station to the local, and the duration of the cached video is merely 5 s. If accessing the live broadcast interface within 5 s, the data buffered to the local may be directly broadcasted by the user, which does not cause the delay of the simultaneously broadcasting. If not starting the live broadcast interface within 5 s, the video program (which is still the 5 s-duration video) of the live broadcast station is continued to buffer and download the video program of the live broadcast station, and the data buffered before is deleted. Of course, the contents above may also employ the other modes, but not limited to the present disclosure.

### Third Embodiment

The disclosure of the method for simultaneously broadcasting the desktop background and the live broadcast interface is described in detail hereinafter.

Setting: after a user A starts the Internet TV, the video program broadcasted in the desktop background of the main menu interface of the current Internet TV is a movie M (starting from 10:00 and ending in 12:00) broadcasted in a certain movie live broadcast station (the movie live broadcast station is called as “movie1 movie channel”; the broadcast address is http://movie1.com; and the program list address is http://list.com). The user A can watch the movie M when clicking into the live broadcast interface of the Internet TV.

The process is as follows.

In step 301, a live broadcast station name “movie1 movie channel” corresponding to a movie M being broadcasted in the desktop background is acquired by calling a live broadcast interface of the desktop background.

In step 302, the program list URL, that is, http://list.com and the live broadcast station broadcast URL, that is, http://movie1.com are extracted from the live broadcast station information acquired according to the live broadcast station name “movie1 movie channel”.

In step 303, when accessing the live broadcast interface, time-comparing is performed for a queried live broadcast station current time (10:00) with the program list information acquired through the program list URL (http://list.com) to look up a program that is broadcasted at the current time, the program is looked up through the live broadcast station broadcast URL (http://movie1.com) and simultaneously broadcasted in the live broadcast interface.

In the embodiment: For step 301, when the movie M is broadcasting in the desktop background, the live broadcast interface provided by the broadcast thread at the bottom layer of the Internet TV system is detected. The information identifier of the current movie M is recorded in the live broadcast interface records, so that the name of the live broadcast station of the movie M may be acquired after recognizing the information identifier of the movie M. In the embodiment, the identifiers of the live broadcast station specifically include the name or domain name and other information of the live broadcast station.

For step 302, the movie live broadcast station is set in the corresponding broadcast server. The corresponding live broadcast station (which may also be the domain name of the corresponding broadcast server, the domain name information is stored in the program information and is acquired by detecting in the step 301) is queried by the user A by means of the name of the live broadcast station when simultaneously broadcasting the corresponding video program through the live broadcast interface. Meanwhile, each live broadcast station in the broadcast service end is provided with a unique broadcast URL and a program list URL.

Accordingly, for step 302, query is performed in the corresponding broadcast server according to the name “movie1 movie channel” of the movie live broadcast station, and the broadcast URL:http://movie1.com of the movie live broadcast station is also looked up correspondingly when querying the “movie1 movie channel”. At the same time, the corresponding program list URL:http://list.com is looked up.

For step 303, after accessing the live broadcast interface, the user A queries the live broadcast station current time (queried as 10:00), looks up the movie M that should be broadcasted in the program list at 10:00 according to the program list information acquired by the program list URL (http://list.com), accesses the URL:http://movie1.com of the “movie1 movie channel”, looks up the movie M broadcasted in the desktop background, and simultaneously broadcasts the broadcast time schedule of the looked movie M in the live broadcast interface according to the schedule of the movie M broadcasted in the desktop background. For instance: the movie M broadcasted in the desktop background is broadcasted to 1:12:31 (that is, 1-hour 12-minute 31-second), then, the http://movie1.com is accessed and the movie M is looked up, and simultaneous broadcast is performed in the live broadcast interface after the schedule is adjusted to 1:12:31.

It should be noted that the corresponding server when broadcasting in the desktop background of the Internet TV is inconsistent with the corresponding server when broadcasting in the live broadcast interface. Therefore, a certain delay phenomenon will occur when simultaneously broadcasting in the live broadcast interface after accessing the http://movie1.com, looking up the movie M and adjusting the schedule as 1:12:31). That is, the movie M is broadcasted from 1:12:31 (however, the movie M in the desktop background may have been broadcasted to 1:12:32 or 1:12:33) after the user A accesses the live broadcast interface, that is to say, delay of is to 2 s may exist during the switching of the interface.

Accordingly, the broadcast address may be directly accessed after querying the broadcast address http://movie1.com of the “movie1 movie channel” in the embodiment in order to eliminate the delay, and the broadcast cache processing is performed to the movie M in the “movie1 movie channel”. The cached movie M is directly broadcasted to effectively eliminate the delay of 1 s to 2 s after the user A starts the live broadcast interface.

### Fourth Embodiment

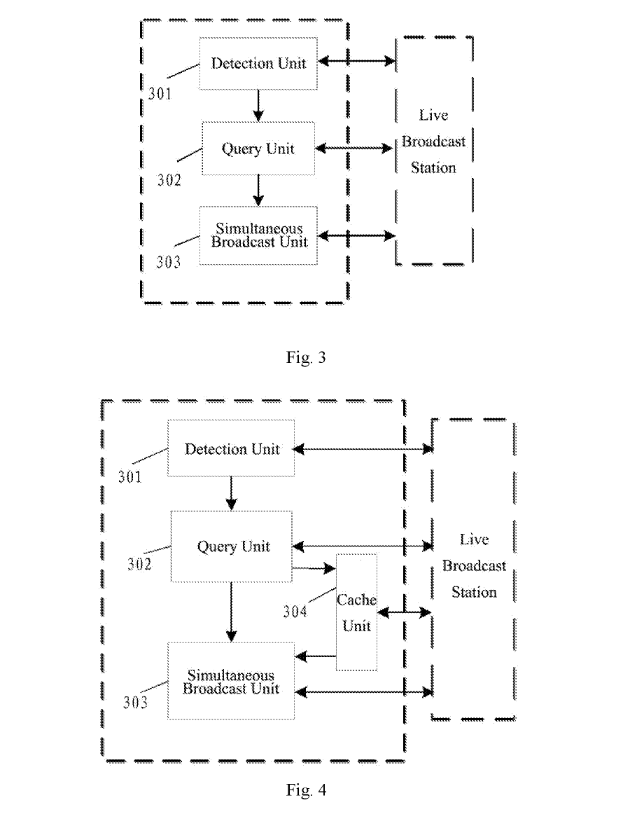

FIG. 3 shows a system for simultaneously broadcasting a desktop background and a live broadcast interface according to the fourth embodiment of the present disclosure, which is coupled with a live broadcast station. The system includes a detection unit 301, a query unit 302 and a simultaneous broadcast unit 303.

In the embodiment, the detection unit 301 is coupled with the live broadcast station and the query unit 302, and is configured to acquire the live broadcast station name corresponding to the program being broadcasted in the desktop background by calling the live broadcast interface of the desktop background and send to the query unit 302.

The query unit 302 is coupled with the detection unit 301 and the simultaneous broadcast unit 303 and is configured to extract the program list address and the live broadcast station broadcast address from the live broadcast station information acquired according to the live broadcast station name.

The simultaneous broadcast unit 303 is coupled with the query unit 302 and is configured to time-compare a queried live broadcast station current time with program list information acquired through the program list address to look up a program that is broadcasted at the current time when accessing the live broadcast interface, look up the program through the live broadcast station broadcast address and simultaneously broadcast in the live broadcast interface.

For the detection unit 301, the live broadcast interface of a broadcast thread corresponding to the desktop background is detected when broadcasting the program in the desktop background, and the live broadcast station name corresponding to the program is extracted from the live broadcast interface of the broadcast thread to send to the query unit 302.

Wherein, the broadcast thread may be a broadcast thread at the bottom layer of the Internet TV system. The data flow (transmission type of video formed during the course of transmission) transmitted from the service end is converted by the broadcast thread into a video program through the corresponding live broadcast interface to broadcast. The corresponding program information is written by the live broadcast station of the service end in the data corresponding to the video program in a mode of information identifier according to setting. When the video program is transmitted, the information identifier may be extracted from the live broadcast interface of the broadcast thread, so as to further acquire the live broadcast station name.

The query unit 302 is specifically configured to query the corresponding live broadcast station according to the live broadcast station name, and acquire the corresponding live broadcast station information through a query interface of the live broadcast station.

It should be noted that the live broadcast station is set in the server of the service end. If the user simultaneously broadcasts the corresponding video programs through the live broadcast interface, the corresponding live broadcast station needs to be queried in the domain name of the server or the name of the live broadcast station. Accordingly, the live broadcast station information extracted by the query unit 302 from the program information may be specifically the name of the live broadcast station or the server domain name address corresponding to the live broadcast station, and so on.

The simultaneous broadcast unit 303 is specifically configured to access the program list address of the live broadcast station to acquire the program list information when accessing the live broadcast interface, time-comparing is performed with the live broadcast station current time queried by accessing, the program that is broadcasted at the current time in the program list represented by the program list information is looked up, the broadcast address of the live broadcast station is accessed to look up the program, and the queried program is simultaneously broadcasted in the live broadcast interface according to the broadcast time schedule of the program broadcasted in the desktop background.

### Fifth Embodiment

In the fourth embodiment above, as the server corresponding to the program broadcasted in the desktop background is inconsistent with the service end corresponding to the program broadcasted in the live broadcast interface, the broadcast address of the live broadcast station in the service end corresponding to the live broadcast interface will be accessed when recognizing that the user starts the operation of the live broadcast interface, which causes that the video program broadcasted has a certain delay phenomenon after querying the corresponding live broadcast station by the program information corresponding to the program in the desktop background and simultaneously broadcasting.

Therefore, in order to slow down the delay phenomenon during simultaneously broadcasting, a cache unit 304 is added in the system of the embodiment above, which is specifically as shown in FIG. 4, wherein

The cache unit 304 is coupled with the query unit 302, the simultaneous broadcast unit 303 and the live broadcast station and is configured to query the broadcast address of the live broadcast station; and the program content corresponding to the program that is broadcasted in the desktop background is looked up in the broadcast station by accessing the live broadcast station according to the broadcast address of the live broadcast station to perform the broadcast cache processing. Accordingly, a certain duration of video program is broadcasted in the live broadcast station is cached locally. When accessing the live broadcast interface, the user may directly broadcast the data cached locally, which does not cause the delay of the simultaneously broadcasting.

It should be noted that when performing the cache processing, the cache unit 304 caches the video program broadcasted according to the preset duration. The duration is a fixed value. The cache unit 304 may cache the data to be cached in an internal memory, a hard disk or other types of memories, which is not limited herein.

For the setting of the caching duration of the video program, specifically for instance: the caching duration is set as 5 s, that is, the Internet TV pre-caches and downloads the video program of the corresponding live broadcast station to the local, and the duration of the cached video is merely 5 s. If accessing the live broadcast interface within 5 s, the data cached to the local may be directly broadcasted by the user, which does not cause the delay of the simultaneously broadcasting. If not starting the live broadcast interface within 5 s, the video program (which is still the 5 s-duration video) of the live broadcast station is continued to cache and download the video program of the live broadcast station, and the data cached before is deleted. Of course, the contents above may also employ the other modes, but not limited to the present disclosure.

### Sixth Embodiment

FIG. 5 shows an apparatus for simultaneously broadcasting a desktop background and a live broadcast interface. The apparatus comprising:

a processor 51; and

an memory 52 for storing commands executed by the processor 51;

wherein the processor 51 is configured to:

acquiring a live broadcast station name corresponding to a program being broadcasted in the desktop background by calling a live broadcast interface of the desktop background; extracting a program list address and a live broadcast station broadcast address from live broadcast station information acquired according to the live broadcast station name; and when accessing the live broadcast interface, time-comparing a queried live broadcast station current time with program list information acquired through the program list address to look up a program that is broadcasted at the current time, looking up the program through the live broadcast station broadcast address and simultaneously broadcasting in the live broadcast interface.

In the embodiment, the processor 51 is further configured to:

when broadcasting the program in the desktop background, detecting the live broadcast interface of a broadcast thread corresponding to the desktop background, and extracting the live broadcast station name corresponding to the program from the live broadcast interface of the broadcast thread.

In the embodiment, the processor 51 is further configured to:

querying the corresponding live broadcast station according to the live broadcast station name, and acquiring the corresponding live broadcast station information through a query interface of the live broadcast station.

In the embodiment, the processor 51 is further configured to:

accessing the program list address of the live broadcast station to acquire the program list information, time-comparing with the live broadcast station current time queried by accessing, and looking up the program that is broadcasted at the current time in the program list represented by the program list information; accessing the broadcast address of the live broadcast station to look up the program; and simultaneously broadcasting the queried program in the live broadcast interface according to the broadcast time schedule of the program broadcasted in the desktop background.

In the embodiment, the processor 51 is further configured to:

querying the broadcast address of the live broadcast station; accessing the live broadcast station according to the queried broadcast address of the live broadcast station, and looking up the corresponding program content of the program that is broadcasted in the desktop background in the live broadcast station to perform broadcast cache processing.

As the embodiments of the present disclosure have been described in detail in the method portion, the description to the system portion corresponding to the method portion and related in the embodiments is omitted and not elaborated any more. The description to the specific contents in the system may refer to the contents of the method embodiment, which is not specifically limited herein any more.

Compared with the prior art, the method and system for simultaneously broadcasting the desktop background and the live broadcast interface described in the present disclosure achieve the following effects:

1) After a user accesses the main menu interface of the Internet TV, the present disclosure may immediately acquire the live broadcast station information corresponding to the program broadcasted by the desktop background of the main menu interface, and query the corresponding live broadcast station according to the live broadcast station information, which effectively solves the simultaneous broadcast problem between the desktop background and the live broadcast interface.

2) The present disclosure may further query a uniform live broadcast station through the live broadcast station information, which ensures the program broadcasted by the desktop background of the main menu interface is consistent with the program broadcasted by the live broadcast interface, and effectively improves the watching experience of the user.

It should be further noted that, the terms “include”, “comprise” or any variation thereof herein refer to “include but not limited to”. Therefore, in the context of a process, method, commodity or system that includes a series of elements, the process, method, commodity or system not only includes such elements, but also includes other elements not specified expressly, or may include inherent elements of the process, method, commodity or device. Unless otherwise specified, in the context of “include a . . . ”, the process, method, commodity of system that includes or comprises the specified elements may also include other identical elements.

Those skilled in the art should understand the embodiments of the present disclosure may provide a method, a system or a computer program product. Therefore, the present disclosure may employ the form of a complete hardware embodiment, a complete software embodiment or the embodiment combining the software and the hardware. Moreover, the present disclosure may employ the form of the computer program product performed on one or more computer available storage media including a computer available program code (including but not limited to magnetic disc memory, CD-ROM, optical memory and the like).

The description above is merely the embodiments of the present disclosure, but not limited to the present disclosure. For those skilled in the art, various modifications and changes may be made in the present disclosure. Any modifications, equivalent replacements, improvements and the like made within the spirit and principle of the present disclosure shall all fall within the scope of the claims in the present disclosure.

1. A method for simultaneously broadcasting a desktop background and a live broadcast interface, comprising:
acquiring a live broadcast station name corresponding to a program being broadcasted in the desktop background by calling a live broadcast interface of the desktop background;
extracting a program list address and a live broadcast station broadcast address from live broadcast station information acquired according to the live broadcast station name; and
when accessing the live broadcast interface, time-comparing a queried live broadcast station current time with program list information acquired through the program list address to look up a program that is broadcasted at the current time, looking up the program through the live broadcast station broadcast address and simultaneously broadcasting in the live broadcast interface.

2. The method for simultaneously broadcasting the desktop background and the live broadcast interface according to claim 1, wherein acquiring the live broadcast station name corresponding to the program being broadcasted in the desktop background by calling the live broadcast interface of the desktop background further comprises:
when broadcasting the program in the desktop background, detecting the live broadcast interface of a broadcast thread corresponding to the desktop background, and extracting the live broadcast station name corresponding to the program from the live broadcast interface of the broadcast thread.

3. The method for simultaneously broadcasting the desktop background and the live broadcast interface according to claim 1, wherein before extracting the program list address and the live broadcast station broadcast address from live broadcast station information acquired according to the live broadcast station name, the method further comprises:
querying the corresponding live broadcast station according to the live broadcast station name, and acquiring the corresponding live broadcast station information through a query interface of the live broadcast station.

4. The method for simultaneously broadcasting the desktop background and the live broadcast interface according to claim 1, wherein when accessing the live broadcast interface, time-comparing a queried live broadcast station current time with program list information acquired through the program list address to look up a program that is broadcasted at the current time, looking up the program through the live broadcast station broadcast address and simultaneously broadcasting in the live broadcast interface further comprises:
accessing the program list address of the live broadcast station to acquire the program list information, time-comparing with the live broadcast station current time queried by accessing, and looking up the program that is broadcasted at the current time in the program list represented by the program list information;
accessing the broadcast address of the live broadcast station to look up the program; and
simultaneously broadcasting the queried program in the live broadcast interface according to the broadcast time schedule of the program broadcasted in the desktop background.

5. The method for simultaneously broadcasting the desktop background and the live broadcast interface according to claim 1, further comprising:
querying the broadcast address of the live broadcast station; accessing the live broadcast station according to the queried broadcast address of the live broadcast station, and looking up the corresponding program content of the program that is broadcasted in the desktop background in the live broadcast station to perform broadcast cache processing.

6. A system for simultaneously broadcasting a desktop background and a live broadcast interface, characterized in that, the system comprises: a detection unit, a query unit and a simultaneous broadcast unit, wherein:
the detection unit is configured to acquire the live broadcast station name corresponding to a program being broadcasted in the desktop background by calling a live broadcast interface of the desktop background and send to the query unit;
the query unit is configured to extract a program list address and a live broadcast station broadcast address from live broadcast station information acquired according to the live broadcast station name; and
the simultaneous broadcast unit is configured to, when accessing the live broadcast interface, time-compare a queried live broadcast station current time with program list information acquired through the program list address to look up a program that is broadcasted at the current time, look up the program through the live broadcast station broadcast address and simultaneously broadcast in the live broadcast interface.

7. The system for simultaneously broadcasting the desktop background and the live broadcast interface according to claim 6, wherein the detection unit is further configured to:
when broadcasting the program in the desktop background, detect the live broadcast interface of a broadcast thread corresponding to the desktop background, and extract the live broadcast station name corresponding to the program from the live broadcast interface of the broadcast thread.

8. The system for simultaneously broadcasting the desktop background and the live broadcast interface according to claim 6, wherein the query unit is further configured to:
query the corresponding live broadcast station according to the live broadcast station name, and acquire the corresponding live broadcast station information through a query interface of the live broadcast station.

9. The system for simultaneously broadcasting the desktop background and the live broadcast interface according to claim 6, wherein the simultaneous broadcast unit is further configured to:
access the program list address of the live broadcast station to acquire the program list information, time-compare with the live broadcast station current time queried by accessing, look up the program that is broadcasted at the current time in the program list represented by the program list information, access the broadcast address of the live broadcast station to look up the program, and simultaneously broadcast the queried program in the live broadcast interface according to the broadcast time schedule of the program broadcasted in the desktop background.

10. The system for simultaneously broadcasting the desktop background and the live broadcast interface according to claim 6, further comprising:
a cache unit, configured to query the broadcast address of the live broadcast station; access the live broadcast station according to the queried broadcast address of the live broadcast station, and look up the corresponding program content of the program that is broadcasted in the desktop background in the live broadcast station to perform broadcast cache processing.

11. An apparatus for simultaneously broadcasting a desktop background and a live broadcast interface, comprising:
a processor; and
an memory for storing commands executed by the processor;
wherein the processor is configured to:
acquiring a live broadcast station name corresponding to a program being broadcasted in the desktop background by calling a live broadcast interface of the desktop background; extracting a program list address and a live broadcast station broadcast address from live broadcast station information acquired according to the live broadcast station name; and when accessing the live broadcast interface, time-comparing a queried live broadcast station current time with program list information acquired through the program list address to look up a program that is broadcasted at the current time, looking up the program through the live broadcast station broadcast address and simultaneously broadcasting in the live broadcast interface.

12. The apparatus for simultaneously broadcasting the desktop background and the live broadcast interface according to claim 11, wherein the processor is further configured to:
when broadcasting the program in the desktop background, detecting the live broadcast interface of a broadcast thread corresponding to the desktop background, and extracting the live broadcast station name corresponding to the program from the live broadcast interface of the broadcast thread.

13. The apparatus for simultaneously broadcasting the desktop background and the live broadcast interface according to claim 11, wherein the processor is further configured to:
querying the corresponding live broadcast station according to the live broadcast station name, and acquiring the corresponding live broadcast station information through a query interface of the live broadcast station.

14. The apparatus for simultaneously broadcasting the desktop background and the live broadcast interface according to claim 11, wherein the processor is further configured to:
accessing the program list address of the live broadcast station to acquire the program list information, time-comparing with the live broadcast station current time queried by accessing, and looking up the program that is broadcasted at the current time in the program list represented by the program list information; accessing the broadcast address of the live broadcast station to look up the program; and simultaneously broadcasting the queried program in the live broadcast interface according to the broadcast time schedule of the program broadcasted in the desktop background.

15. The apparatus for simultaneously broadcasting the desktop background and the live broadcast interface according to claim 11, wherein the processor is further configured to:
querying the broadcast address of the live broadcast station; accessing the live broadcast station according to the queried broadcast address of the live broadcast station, and looking up the corresponding program content of the program that is broadcasted in the desktop background in the live broadcast station to perform broadcast cache processing.
